(19) United States
(12) Patent Application Publication
(10) Pub. No.: US 2021/0188526 A1
(43) Pub. Date: Jun. 24, 2021

(54) DISPENSER AND METHODS OF MAKING AND USING SAME

(71) Applicant: Bobby Gene Braziel, Oklahoma City, OK (US)

(72) Inventor: Bobby Gene Braziel, Oklahoma City, OK (US)

(21) Appl. No.: 17/121,180

(22) Filed: Dec. 14, 2020

Related U.S. Application Data
(60) Provisional application No. 62/950,750, filed on Dec. 19, 2019.

(51) Int. Cl. B65D 83/30; B05B 1/02

(52) U.S. Cl. CPC B65D 83/30; B05B 1/02

(57) ABSTRACT

A dispenser for a shaving cream can wherein the dispenser has a channel and a tip. The channel has a first end and a second end such that a portion of the channel substantially tapers outwardly toward the second end. The tip is connected to the second end of the channel wherein the tip substantially curves outwardly from the second end of the channel.

### CROSS-REFERENCE TO RELATED APPLICATIONS

This application claims benefit under 35 U.S.C. 119(e) of U.S. Provisional Application Ser. No. 62/950,750, filed Dec. 19, 2019, which is hereby expressly incorporated herein by reference in its entirety.

### STATEMENT REGARDING FEDERALLY SPONSORED RESEARCH OR DEVELOPMENT

Not applicable.

### FIELD OF THE INVENTION

The present disclosure relates generally to a shaving cream dispenser, and more particularly, not by way of limitation, to an improved shaving cream dispenser for allowing more controlled flow of shaving cream for use by an individual.

### BACKGROUND OF THE INVENTION

People routinely use cream from an aerosol can for shaving. Conventional shaving cream cans are generally provided with a manual valve and a small dispenser configured to deliver shaving cream to a portion of an individual to be applied to an individual. Typically, this process is wasteful, messy and time consuming.

To this end, a need exists for an improved dispenser that allows an individual more control of the flow of shaving cream exiting a can than currently is provided in existing dispensers. It is to such a device that the present disclosure is directed.

### BRIEF DESCRIPTION OF THE DRAWING(S)

FIG. 1 is a side elevational view of one embodiment of a dispenser, the dispenser connected to a conventional shaving cream can.

FIG. 2 is a bottom view of the dispenser of FIG. 1.

FIG. 3 is a front view of the dispenser of FIG. 1.

FIG. 4 is another embodiment of a dispenser positioned in a shaving cream can.

### DETAILED DESCRIPTION OF THE INVENTION

Before explaining at least one embodiment of the inventive concept disclosed herein in detail, it is to be understood that the inventive concept is not limited in its application to the details of construction, experiments, exemplary data, and/or the arrangement of the components set forth in the following description, or illustrated in the drawings. The presently disclosed and claimed inventive concept is capable of other embodiments or of being practiced or carried out in various ways. Also, it is to be understood that the phraseology and terminology employed herein is for purpose of description only and should not be regarded as limiting in any way.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

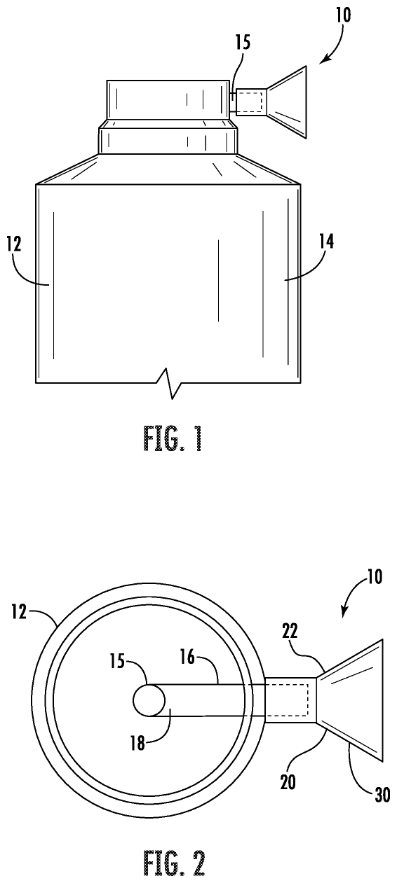

Referring now to the drawings, and more particularly to FIGS. 1-3, shown therein is an exemplary embodiment of a dispenser 10 constructed in accordance with the inventive concepts disclosed herein removably attachable to an existing shaving cream can 12. The conventional shaving cream can 12 has a body 14 and a dispensing nozzle 15. However, in another embodiment, it should be understood by one of ordinary skill in the art that the dispenser 10 may be configured to be constructed as part of a shaving cream can. It is contemplated, in one embodiment, that the dispenser 10 is constructed from one piece of material, however, it should be understood that the dispenser 10 may be constructed from various components. The dispenser 10 is preferably made of durable materials which are strong enough to allow for flow of shaving cream from the dispenser 10. The dispenser 10 may be constructed from a variety of durable and resilient materials, such as for example, polymeric materials, plastics, thermoplastics, elastomers, rubber, cardboard, metals such as aluminum, steel, titanium, magnesium or alloys containing these metals, and composite materials which are capable of providing the desired strength and durability for the dispenser 10. Further, it should be understood that the dispenser 10 may be constructed from materials that may be water-resistant, anti-microbial, or waterproof so that the dispenser 10 may be easily cleaned after use.

In one embodiment, the dispenser 10 is provided with a channel 16 having a first end 18 and a second end 20. The first end 18 of the channel 16 is removably attachable to the dispensing nozzle 14 of the shaving cream can 12 such that the channel 16 of the dispenser 10 is in fluid communication with the nozzle 15 of the shaving cream can 12. The channel 16 may be configured in various sizes and dimensions for attaching to various sized dispensing nozzles.

The channel 16 extends a desired distance from the first end 18. A portion 22 of the channel 16 substantially tapers outwardly toward the second end 20 of the channel 16 and a rim 22 of the can 12. The channel 16 is configured wider at the portion that substantially tapers outwardly toward the second end 20 of the channel 16.

A tip 30 is connected to the second end 20 of the channel 16 wherein the tip 30 substantially curves outwardly or flares from the second end 20 of the channel 16 of the dispenser 10.

In use, the conventional valve of the shaving cream can 12 may be depressed by an individual's finger of a first hand, while the can 12 is held in the first hand and shaving cream leaves the dispensing nozzle of the shaving cream can 12 and flows through the channel 16 of the dispenser 10 and out of the flared tip 30 onto a portion of an individual's body to be shaved. It will be understood by one of ordinary skill in the art that the dispenser 10 allows for a controlled flow of shaving cream and enables individuals to apply the shaving cream directly from the can onto the portion of the body to be shaved, thereby reducing the total amount of shaving cream application time and use of the shaving cream, thus providing economic and time saving improvements.

One purpose of the dispenser 10 is to allow for the shaving cream to exit in a pattern that will be of adequate size, shape and consistency to adhere to the portion of the individual's body to be shaved. The dispenser 10 allows the shaving cream to be delivered directly thereby eliminating the time consuming process of dispensing shaving cream from the can onto a hand repetitively. The dispenser also allows for a faster and more uniform application thus allowing the shaving cream to stay soft and fluffy preventing the shaving cream from drying out before shaving begins. Thus, reducing stress and providing a close, comfortable shave. The dispenser 10 may also be utilized by veterinarians, pet groomers, surgeons, barbers, or the like that may shave the hair off an individual or animal.

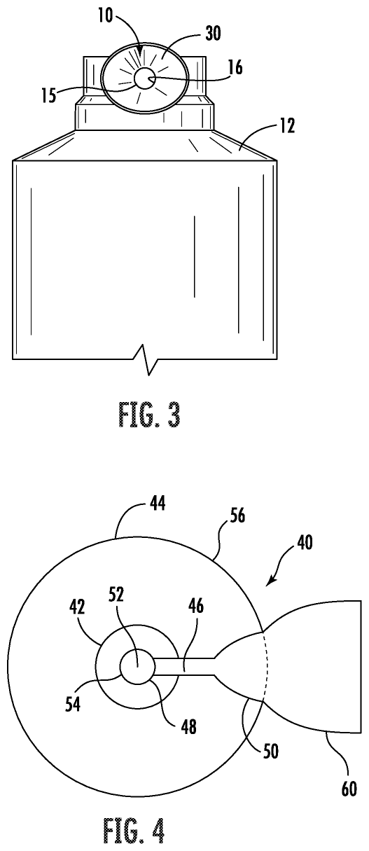

Referring now to FIG. 4, shown therein is another embodiment of a dispenser 40. The dispenser 40 is positioned in a cap 42 of a shaving cream can 44. The dispenser 40 is provided with a channel 46 having a first end 48 and a second end 50. The first end 48 of the channel 46 is positioned at the opening 52 of a shaving cream can tube 54. The channel 46 extends a distance from the opening 52 and then substantially tapers outwardly toward a rim 56 of the shaving cream can 44 near the second end 50 of the channel 46. A tip 60 is connected to the second end 50 of the channel 46 wherein the tip 60 substantially curves outwardly or flares away from the second end 50 of the channel 46 of the dispenser 40 and the rim 56 of the shaving cream can 44.

From the above description, it is clear that the inventive concept(s) disclosed herein is well adapted to carry out the objects and to attain the advantages mentioned herein as well as those inherent in the inventive concept disclosed herein. While exemplary embodiments of the inventive concept disclosed herein have been described for purposes of this disclosure, it will be understood that numerous changes may be made which will readily suggest themselves to those skilled in the art and which are accomplished without departing from the scope of the inventive concept disclosed herein and defined by the appended claims.

What is claimed is:

1. A dispenser for a shaving cream can, comprising:
a channel having a first end and a second end such that a portion of the channel substantially tapers outwardly toward the second end; and
a tip connected to the second end of the channel wherein the tip substantially curves outwardly from the second end of the channel.
